(19) United States
(12) Patent Application Publication
(10) Pub. No.: US 2006/0163008 A1
(43) Pub. Date: Jul. 27, 2006

(54) Autonomous linear retarder/motor for safe operation of direct drive gearless, rope-less elevators

(76) Inventor: Michael Godwin, Cagnes-Sur-mer (FR)

Correspondence Address: JINAN GLASGOW, 300 N. GREENE ST., SUITE 1600, P.O. BOX 2974, GREENSBORO, NC, 27401, US

(21) Appl. No.: 11/041,596

(22) Filed: Jan. 24, 2005

(51) Int. Cl. B66B 1/32

(52) U.S. Cl. 187/288

(57) ABSTRACT

A gearless, ropeless elevator according to the present invention includes a universal independent linear electromagnetic retarder as an essential component that will ensure safe and comfortable transit for passengers going up and down. By design sufficient number of independent retarders are securely fixed to the independent passenger cabin such that under free fall conditions due to power failure for example the gross weight of the gearless, ropeless elevator assembly will be counter balanced by the force generated in the retarders so permitting it to descend at a slow speed until resting on its buffers. The independent universal retarder unit which can also function as a motor includes not only a fail safe brake capable of slowing and stopping a gearless, ropeless elevator assembly but also a UPS unit capable of supplying the retarder with sufficient power for a few seconds to permit the independent cabin and passengers to slowdown comfortably from high speed. Both are fed from an onboard continuously charged battery unit which also provides supplies to the logic control circuits and switches.

### FIELD OF INVENTION

The present invention relates generally to all elevator systems for buildings and more particularly to the safety aspect of multiple elevators in the same shaft which permit a higher rate of transporting building occupants from one level to another than any conventional roped system of elevator in one dedicated shaft.

### DESCRIPTION OF THE PRIOR ART

Typically, tall buildings have elevator systems for movement of occupants between floors. As buildings get higher the core space requirements necessary to achieve an acceptable quality and quantity of elevator service with roped elevators becomes a major problem.

Double deck shuttle elevators are the only present day products available; each shuttle working in a dedicated shaft a number of which will take a lot of core space.

Thus there is a need for using each shuttle elevator shaft more efficiently by having multiple elevators in the same shaft so increasing the quantity of occupants transported at low interval to and from some high level in a building without the need for the high speeds and large numbers of conventional elevator shuttles that would otherwise be required.

The obvious benefit to the building owner of this new arrangement is the consequent reduction in core area with the accumulated savings that such a reduction must bring.

### SUMMARY OF INVENTION

The present invention is directed to providing the means for safe and comfortable operation of ropeless/gearless multiple elevators transporting occupants in high buildings from one level to another using as that means fail safe independent linear retarders, which also function as motors, fixed directly to the cabin which can move upwards in its own guide system independent of the thrust motors which have a separate frame and guide system. This arrangement permits under emergency stop or power failure at high speed in the up direction for the cabin to continue travelling under a controlled slowdown even though the thrust motors and brakes have stopped instantly. Power for driving the cabin and retarders/motors for the several seconds required for comfortable slowdown is provided by the storage element within the uninterruptible power supply that connects to the retarder at the instant power failure is detected.

In this example elevator cars can circulate around twin shafts in either clockwise or anticlockwise direction. In a preferred embodiment of the present invention thrust to move the elevator cars in the up direction can be provided by a permanent magnet linear synchronous motor of sufficient power to propel a fully loaded elevator in an upward journey from a lower terminal to an upper terminal with a journey time not exceeding one minute.

Controlled descent from upper terminal to lower terminal is achieved in a similar manner. To ensure safety of passengers the present invention is fixed directly to each elevator cabin to provide the necessary fail safe retardation that at all times and conditions will prevent the free fall of the elevator cabin should the thrust motor fail or total supply is lost.

The present invention is directed to providing this essential element so permitting the full exploitation of gearless/rope-less direct drive multiple elevator cars in a single shaft.

These and other aspects of the present invention will become apparent to those skilled in the art after a reading of the following description of the preferred embodiment when considered with the drawings.

### BRIEF DESCRIPTION OF DRAWINGS

FIG. 1 shows an overall view of a possible direct drive gearless/rope-less installation in a tall building according to the present invention.

FIG. 2 shows the twin UP/DN shafts with one elevator approaching the top terminal, one elevator in transit across the shafts, and one elevator just having been dispatched from the upper terminal travelling to the lower terminal.

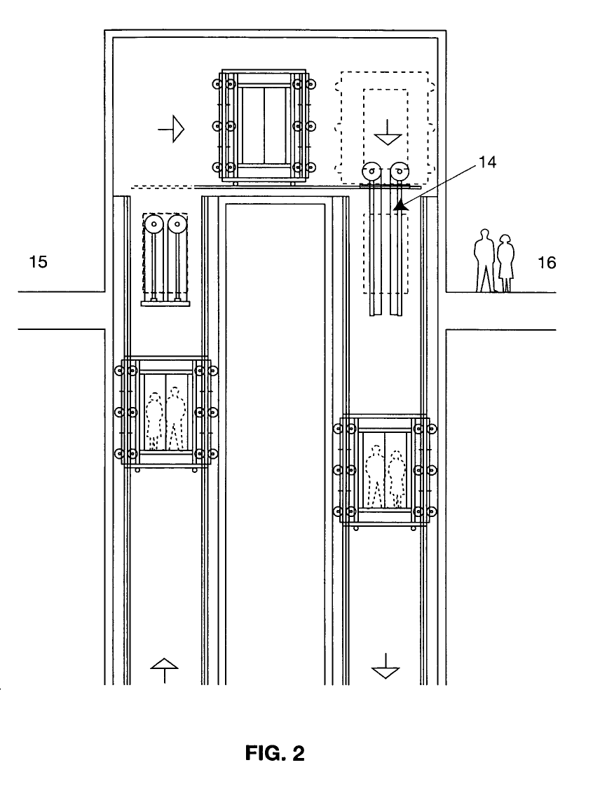

FIG. 3 shows the twin shafts with one DN elevator approaching the lower terminal, one elevator in transit across the shafts with the hydraulic lifter in position ready to receive it whilst a third elevator has been dispatched on its upward journey.

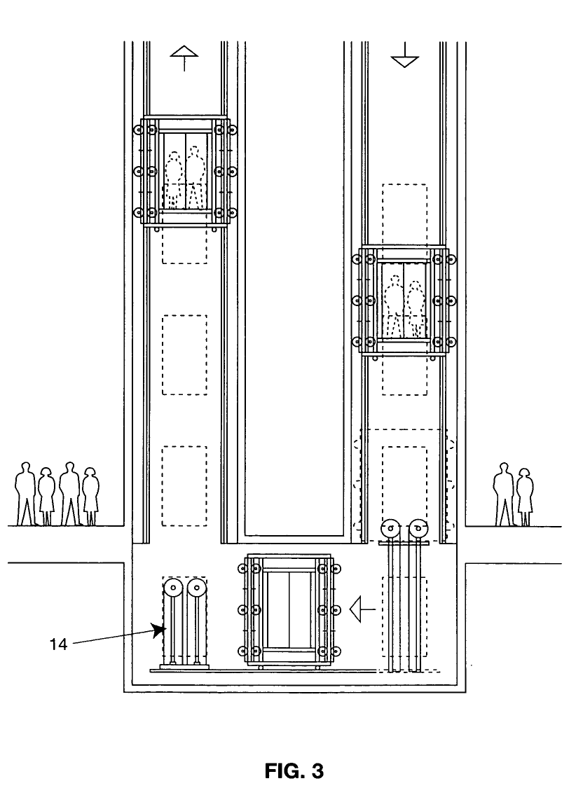

FIG. 4 shows a plan of the twin shafts with elevator cars and their slings with thrust motors and the integral autonomous fail-safe retarders attached.

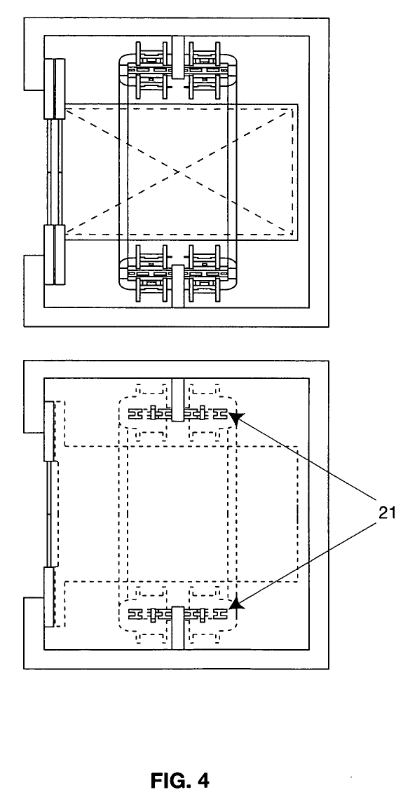

FIG. 5 shows a front and side elevation of the elevator travelling up or down depicting the cab and its entrances.

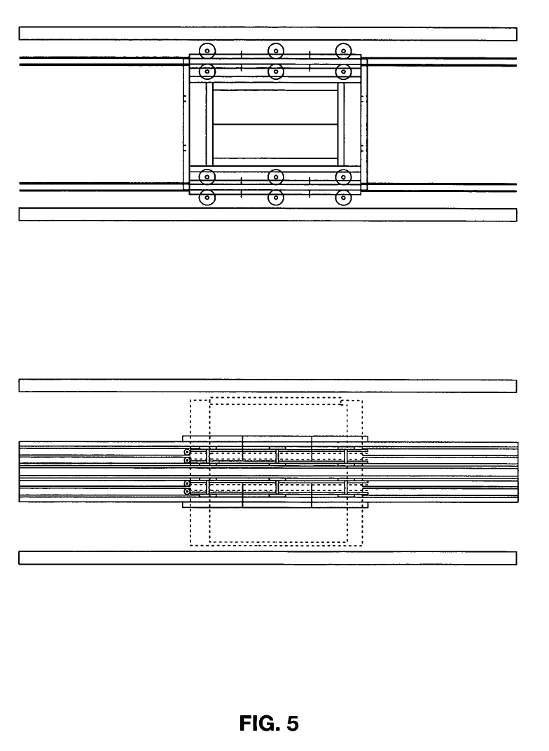

FIG. 6 shows a larger scale plan of one elevator with its eight thrust motors and its four embedded autonomous fail-safe retarders.

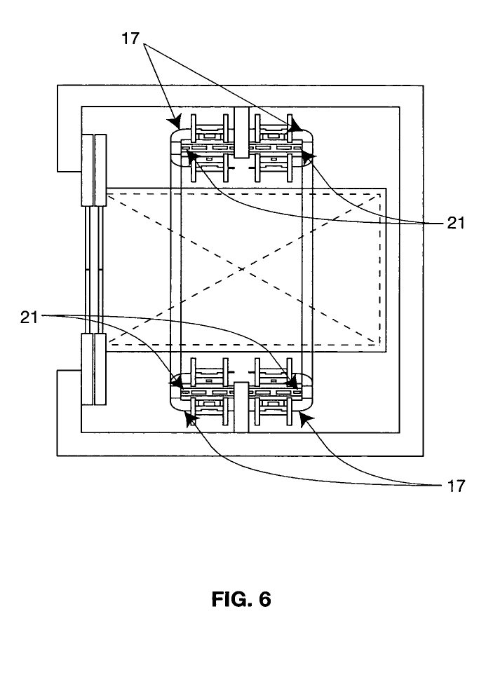

FIG. 7 shows a typical braking characteristic of one 0.5 m length of tuned retarder stator section.

FIG. 8 shows the basic tuned retarder circuit consisting of inductance of stator winding (L), load resistance (R) and Tuning Capacitor (C).

FIG. 9 shows a possible control circuit of one retarder.

FIG. 10 shows a schematic of one section of 3 meter autonomous linear retarder capable of producing a retarding force of 9000 Newton's at approximately 0.5 m/s.

### DETAILED DESCRIPTION OF PREFERRED EMBODIMENTS

In the following description like reference characters, designate like or corresponding parts throughout several views. Also in the following description it is to be understood that such terms as forward, rearward, front, back, right, left, upwardly, downwardly, and the like, are words of convenience are not to be construed as limiting terms.

A gearless, ropeless elevator according to the present invention is embodied by and/or includes a universal independent linear electromagnetic retarder as an essential component that will ensure safe and comfortable transit for passengers going up and down. By design sufficient number of independent retarders are securely fixed to the independent passenger cabin such that under free fall conditions due to power failure for example the gross weight of the gearless, ropeless elevator assembly will be counter balanced by the force generated in the retarders so permitting it to descend at a slow speed until resting on its buffers. The independent universal retarder unit, which is also operable to function as a motor, includes not only a fail safe brake capable of slowing and stopping a gearless, ropeless elevator assembly but also an uninterruptable power supply (UPS) unit capable of supplying the retarder with sufficient power for a few seconds to permit the independent cabin and passengers to slowdown comfortably from high speed. Both are fed from an onboard continuously charged battery unit which also provides supplies to the logic control circuits and switches.

Referring now to the drawings in general the illustrations are for the purpose of describing a preferred embodiment of the invention and are not intended to limit the invention thereto. The figures collectively and individually illustrate the application of the independent fail safe linear retarder/motor to a direct drive gearless, rope-less elevator according to the present invention generally referenced 10 and its components respectively.

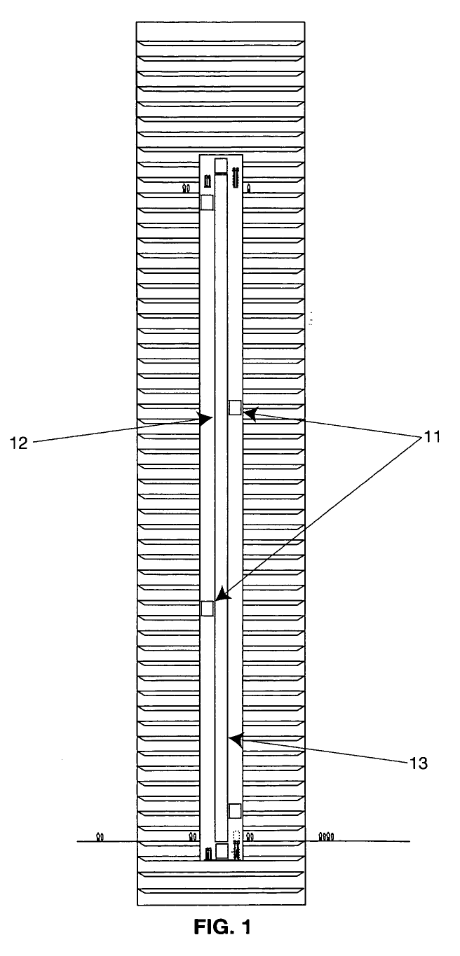

As illustrated in FIG. 1 direct drive gearless/rope-less elevators 11 according to one embodiment of the invention is depicted. The gearless/rope-less elevators travel upwards in shaft 12 and downwards in shaft 13.

Transfer mechanisms 14 move elevators upwards and sideways from shaft 12 to shaft 13 and at the lower level from shaft 13 to shaft 12. Elevators therefore move in a pattern of loading passengers at ground level to travel upwards to a high level lobby 15 where they leave the elevator which is then transferred to the down high level lobby 16 allowing passengers to fill the elevator for a downward journey to the ground level lobby after which the elevator doors are closed. For safe operation of this arrangement of gearless, ropeless elevator system independent fail safe linear retarders/motors are incorporated as an integral part of each elevator cabin so that in the event of power failure to the thrust motors any free fall condition that would cause the elevator to acquire significant kinetic energy in the down direction will automatically energize the retarders/motors which in turn can absorb this excess energy and limit the descent to normal code inspection speeds of approximately 0.5-1.0 m/s.

For example with a gearless, rope-less elevator of gross weight including load of 3500 kg a retarding force must be generated of at least 35000 Newtons to arrest the downward movement under gravity and this force is provided in two ways. Firstly by the fail-safe caliper brakes 17 fixed to each of the four dynamic retarders that can grip the guide rails that extend from top to bottom of both up and down shafts and secondly by tuning each of the four retarders providing approximately 9000 Newtons of braking each at e.g. 0.5 m/s.

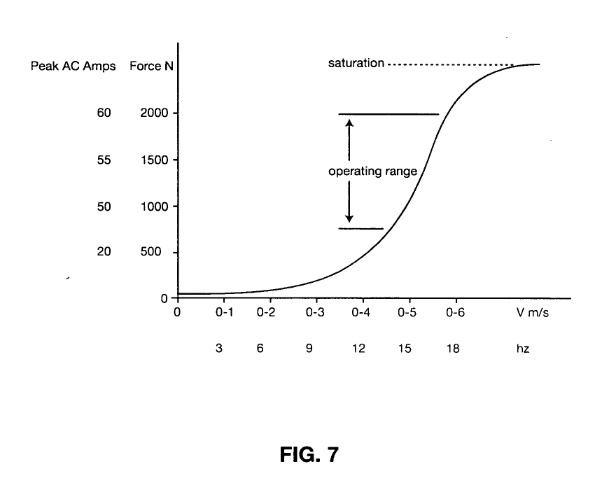

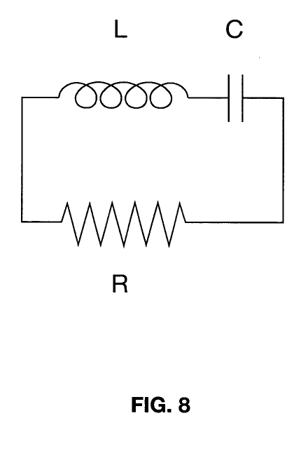

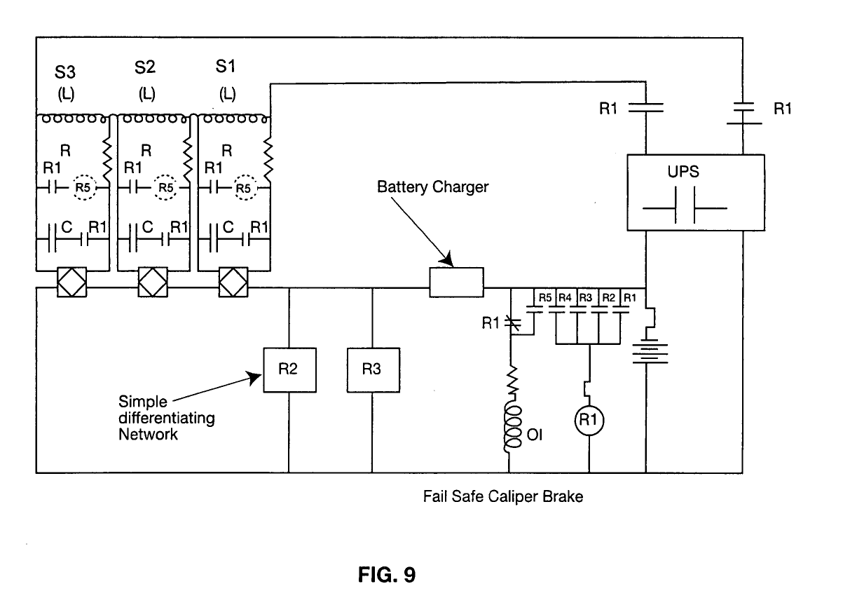

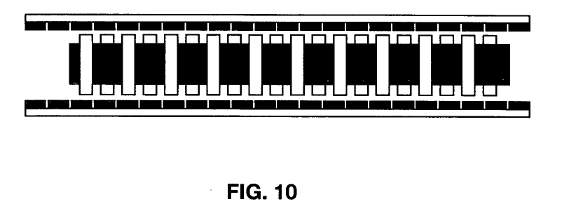

Fail-safe brakes are a normal component of every elevator system and the caliper brakes fitted to each retarder provide the appropriate stopping force, however stopping an elevator mid-shaft under emergency power failure condition is not a satisfactory situation as far as the passengers are concerned as they become trapped. The essential role of the independent fail safe linear retarders is to ensure that when the fail safe elevator brakes are lifted automatically the elevator moves slowly downward to and exit level where the trapped passengers can be released. FIG. 7 shows a typical braking characteristic of the tuned generator stator the circuit of which is depicted in FIG. 8. FIG. 9 shows a schematic of a possible circuit of a three meter independent linear retarder capable not only of producing a retarding force of 12000 newtons at an appropriate down inspection speed but also providing the requisite motoring power to permit the cabin assembly to continue upward at speed for several seconds decelerating at an appropriate rate that would be comfortable for the passengers. Under these conditions with a special lightweight cabin the size of the storage element in the uninterruptible power supply is of manageable proportions i.e. 1-5 farads in contrast to the magnitude of the storage element required if the UPS were simply connected to the main supply for all the thrust motors of all the elevators in a multiple elevator system as already described. The circuit depicts three tuned stator sections, S1, S2, S3, each one meter in length located between the poles of a permanent magnet track that extends top to bottom of the elevator shaft. FIG. 10 shows a typical single stator section construction located in its permanent magnet track with air gap of approximately 3 mm either side. A single 1 meter section when connected, as FIG. 9 can either reduce 4000 newtons of retarding force or alternatively 4000 newtons of motoring force for slowdown from high speed in the up direction. In each three meter length of independent retarder a battery 18 is incorporated both to operate its fail safe caliper type brake 17 and ensure the UPS 19 is always fully charged ready for up slowdown power control. There are also some control circuits and switches.

In each 3-meter length of autonomous retarder a battery supply 18 is incorporated to operate the fail-safe caliper brake 17 and three 1-meter stator sections spatially arranged to provide a three-phase rectified output. There are also some control circuits and switches.

The operation of each retarder is substantially as follows:
A gearless, rope-less elevator is equipped with four autonomous retarders and travels the up/down shafts and transits across at top and bottom as depicted in FIG. 1.

Each gearless, rope-less elevator is mechanically held at each UP or DOWN terminal by detents which form part of the hydraulic lifting/lowering transit system 14 and thus the retarder fail-safe brakes are not required to drop and so remain energised.

When the gearless/rope-less elevator having been transferred across and positioned ready for a downward journey it becomes necessary in order to release the detents that sufficient power and thrust is provided to lift the gross weight of the gearless, rope-less elevator allowing the detents to retract and the brake switch to signal the start of UP or DOWN travel.

The above describes the normal operation of the gearless/rope-less elevators as they circulate around travelling up and down between terminals carrying passengers at approximately 20 second intervals, without the retarders absorbing any significant power.

The following example demonstrates the problem that has to be solved in any gearless/ropeless elevator, and which is solved by the present invention. In any one elevator shaft there may be ten or more elevators running at say 6 m/s each with reasonable load capacity, such as about 20 persons. The power to each elevator would be approximately 250 kw; with 10 elevators this is approximately 2.5 Mw. Even assuming the power controller provided adequate consideration to deal with the individual requirements of each elevator, it would still require a storage element that could provide 2.5 Mw of power for six seconds at least. This amount of energy storage is not merely impractical commercially, but horrendous to contemplate—and this is required for just one elevator shaft. The linear tuned electromagnetic retarder according to the present invention and an elevator including the linear tuned electromagnetic retarder of the present invention both solve this problem is an elegant way, because as the retarder is already energized, due to the elevator moving in the up direction at high speed, this can be monitored, as in a standard UPS as in any application ready to supply the retarder/motor at the instant the power is lost to the thrust motors; however as the elevator cabin is of lightweight construction, the energy storage element in the UPS is of manageable size to provide the power requirement for the six second slowdown. About 30 kg of super capacitors will provide this power, if and when required, as it does not have to take account of the heavy frame and thrust motor. The lightweight cabin with its passengers continue in the up direction for at least 15 m leaving the thrust motor assembly behind, which being subject to a 1 g plus force, and stops almost immediately and applies its fail safe brake. Of course the retarder, once the speed of the cabin has reduced to a low velocity, then functions as a retarder (i.e., it provides retardation or slowdown) and slowly returns the cabin and passengers to the platform where it is buffered for approximately the last two inches. Although the retarder appears to function as a motor, it really is still a retarder, inasmuch as it is retarding in a controlled manner the slowdown of the passenger cabin in the UP direction.

Of course there has to be motoring and power provided to permit the cabin to continue traveling in the up direction, but it is retarding and stops and reverses direction after a short period. As part of the mechanical clamping that is the fail safe brake on the thrust motor frame there is a hook or catch mechanism so that when the brake is lifted during normal elevator operation the hook or catch firmly secures the lightweight cabin to the thrust motor frame. Only when the fail safe brake drops, i.e. in braking mode, does the catch move and release the cabin allowing it to continue to travel if going in the up direction. Stopping in the down direction does not require any securing of the cabin as gravity ensures the cabin stays in place. As everything comes to a standstill after an emergency, i.e. power failure, the fail safe brake energizes and secures the cabin to the thrust motor frame and the retarder then takes over allowing the whole ropeless/gearless elevator to slowly descend to the lowest level. Commenting on the foregoing example, the power for one shaft of ropeless/gearless elevators being estimated at about 2.5 Mw, and with a lightweight cabin assembly being approximately 80 kw, which a UPS can easily deal with for six seconds.

Significantly, and by way of emphasis, according to the present invention the thrust motor assembly is a moving magnet and therefore runs on its own stator track or tracks, which is the main guide system for the elevator. The separate permanent magnet track or tracks by which the retarder and cabin is guided runs parallel to the thrust motor track or tracks. The cabin/retarder is thus independent and is only secured to the thrust motor frame when the fail safe brake is lifted, i.e. energized.

Thus, the passenger cabin, although attached to the same guides as the thrust motor frame on which the cabin sits, is free to be independently driven upward by the retarder/motor during high speed slowdown in the UP direction. Normally the passenger cabin's weight ensures that during normal travel, including normal acceleration and deceleration, the cabin never leaves its platform and of course the fail safe brake activated by the retarder is attached to the thrust motor platform. Thus, the present invention provides a novel retarder and application to elevators that provides for safe descent and is also used to solve the considerable problem of providing a comfortable slowdown from high speed in the up direction at the instant the thrust motors experience loss of supply/power.

In the application of the retarder according to the present invention to passenger elevators, any malfunction, such as loss of power, to the thrust motors could cause any of the following conditions that must be safely handled by the retarders bearing in mind that passenger comfort must be properly accommodated along with avoiding trapping of passengers between terminals.
These conditions are summarised as follows:
a) Over-speed in up or down direction
b) Power failure or brown out of supply to thrust motors
c) Free fall under gravity

d) Providing the means for retarding gearless, ropeless elevators to slowly descend under gravity to a lower level where trapped passengers can exit.

e) Providing a comfortable slowdown from high speed in the up direction of travel.

Significantly, according to the present invention, each retarder, being fully independent, can deal with all of these five conditions without any external power pickoff wireless control or signalling of any kind. They are autonomous.

Condition A

The speed of a gearless, rope-less elevator is continuously monitored by R4 sampling the frequency of the output from each stator winding of a retarder. As soon as a 5% over-speed is detected, R1 energises and self-holds and drops the fail-safe caliper brake B1, arresting the descent comfortably whilst connecting the series circuit of the tuned stator generators slowing the gearless/rope-less elevator to a safe stop. The passengers remain trapped in the elevator wherever that might be whilst at the same time Condition D takes over with controlled descent.

Condition B

Power failure to the thrust motors in the up direction must bring about free fall of the elevator once upward movement ceases. The consequent 1 g acceleration is detected by R2 and again R1 will energise and self-hold, connecting the retarder which after controlled retardation or slowdown limits the descent velocity to 0.5 m/s. Power failure in the down direction will cause the gearless/rope-less elevator to over-speed, as condition A. Over-speed frequency will operate R4 and bring about a safe stop and slow controlled descent.

Condition C

Free fall under gravity implies that the gearless, rope-less elevator is subjected to a 1 g downward acceleration i.e. 9.82 m/s². This is detected simply by R2 differentiating the EMF of the three-phase DC output generated by the retarder. In normal elevator operation, acceleration is always less than 0.1 g therefore the amplitude of the pulse generated by 1 g is sufficient EMF to cause R1 to energise, which in turn connects the tuned retarder generators which immediately provide retarding force together with the fail-safe caliper brake to oppose any further acceleration due to gravity and thus limit descent velocity to 0.5 m/s as condition D.

Condition D

Returning all gearless/rope-less elevators to levels where trapped passengers can exit is brought about by R5 operating at a low frequency after R1 has been activated. This permits the fail-safe brake to lift and allow the retarders to take control and slowly at 0.5 m/s allow the gearless/rope-less elevator to descend until it reaches an interlocked entrance where an authorized technician can open the doors and permit the trapped passengers to exit. Under these conditions, the gearless/rope-less elevators become stacked the lowest elevator carrying the weight of one or more elevators on its framework. Other circuits in the retarder ensure the on board battery remains fully charged at all times thus permitting the fail-safe brake to function satisfactorily. To release R1 an authorised technician must attend to switch off the current to R1 to allow the elevator to return to normal operation.

Condition E

Power failure to the thrust motors occurring with the elevator traveling at high speed in the up direction would result in great discomfort to the passengers due to the rapid stopping of the thrust motors, probably in excess of 1 g. Passengers feet would leave the cabin floor and injuries to their heads might well be sustained. To deal with this conditions the cabin with its retarders being separate from the main thrust motor frame is permitted to continue in the up direction enabling a controlled slowdown to take place. The power to drive the cabin locally at high speed initially so that a comfortable retardation or slowdown can begin is provided by the stored energy in the capacitor in the UPS that is now connected to all retarders. Under these conditions the retarder stators become powerful motors fed via an umbilical cable reeled out from the thrust motor platform. Comfortable slowing in the down direction is simply achieved by adjusting the friction force provided by the fail safe brakes before the retarders take over and return the elevator to a lower level.

Certain modifications and improvements will occur to those skilled in the art upon a reading of the foregoing description. All modifications and improvements have been deleted herein for the sake of conciseness and readability but are properly within the scope of the following claims.

What is claimed is:

1. A gearless, rope-less elevator comprising:
a linear tuned electromagnetic retarder fixed to an elevator carrier housing and coupled to a permanent magnet track extending top to bottom of an elevator shaft as part of an gearless, ropeless elevator assembly, wherein the retarder embodies not only the means to activate its retarding force so enabling the gearless, rope-less elevator to safely descend under gravity at a controlled low velocity, but also to provide the means to power the retarder as a motor for a short period of time to provide for a retardation from high speed if power failure should occur during up travel.

2. The elevator of claim 1 further including a fail safe brake to initiate retardation of the gearless, ropeless elevator to the speed where the energy absorption of the retarder is operable take over control of any downward movement of the elevator.

3. The elevator in claim 1, wherein the means to power the retarder as a motor for a short period of time to provide for a comfortable retardation from high speed if power failure should occur during up travel includes uninterruptible power supply (UPS).

4. The elevator of claim 3, wherein the retarder uses a rectified output from the retarder as the means of providing power for charging the onboard battery and keeping the storage element in the UPS at full charge at all times.

5. The elevator of claim 1, wherein the elevator carrier housing includes a passenger cabin and the elevator is a passenger elevator.

6. The elevator of claim 1, further including a catch mechanism that is connected to the elevator carrier housing and operable as part of a clamping mechanism that is the fail safe brake on a thrust motor frame, so that when the brake is lifted during normal elevator operation, the catch mechanism firmly secures the elevator carrier housing to the thrust motor frame.

7. The elevator of claim 1, wherein the linear tuned electric retarder, the elevator operating within its permanent magnetic track, and the fail safe brake function independently and autonomously.

8. A linear tuned electromagnetic retarder for a gearless, rope-less elevator comprising: a linear tuned electromagnetic retarder affixable to an elevator carrier housing and coupled to a permanent magnet track extending top to bottom of an elevator shaft as part of an gearless, ropeless elevator assembly, wherein the retarder is operable to activate its retarding force to enable the gearless, rope-less elevator to safely descend under gravity at a controlled low velocity, but also to power the retarder as a motor for a short period of time to provide for a retardation from high speed if power failure should occur during up travel.

9. The retarder of claim 8, further including a fail safe brake to initiate retardation of the gearless, ropeless elevator to the speed where the energy absorption of the retarder is operable take over control of any downward movement of the elevator.

10. The retarder in claim 8, wherein the means to power the retarder as a motor for a short period of time to provide for a comfortable retardation from high speed if power failure should occur during up travel includes uninterruptible power supply (UPS).

11. The retarder of claim 10, wherein the retarder uses a rectified output from the retarder as the means of providing power for charging the onboard battery and keeping the storage element in the UPS at full charge at all times.

12. The retarder of claim 8, wherein the elevator carrier housing includes a passenger cabin and the elevator is a passenger elevator.

13. The retarder of claim 8, further including a catch mechanism that is connected to the housing and operable as part of a clamping mechanism that is the fail safe brake on a thrust motor frame, so that when the brake is lifted during normal elevator operation, the catch mechanism firmly secures the elevator carrier housing to the thrust motor frame.

14. The retarder of claim 8, wherein the linear tuned electric retarder, the elevator operating within its permanent magnetic track, and the fail safe brake function independently and autonomously.
